(19) United States
(12) Patent Application Publication
(10) Pub. No.: US 2007/0113357 A1
(43) Pub. Date: May 24, 2007

(54) Method for dyeing a glass fiber nonwoven fabric

(75) Inventor: Thomas Kerle, Furth (DE)

Correspondence Address: DAVID M. QUINLAN, SUITE 300, 32 NASSAU STREET, PRINCETON, NJ, 08542, US

(73) Assignee: PADALUMA GmbH, Markt Erlbach (DE)

(21) Appl. No.: 11/602,077

(22) Filed: Nov. 20, 2006

(30) Foreign Application Priority Data
Nov. 23, 2005 (DE) 10 2005 056 150.0

(51) Int. Cl. D06M 23/00; C09B 67/00

(52) U.S. Cl. 8/494; 8/643

(57) ABSTRACT

A method for dyeing a glass fiber nonwoven fabric comprises applying a dye to an intermediate support or directly to the surface of the glass fiber nonwoven fabric and applying heat to convert the dye to the gaseous state and/or to an aerosol, whereby the dye at least partially penetrates the interior volume of the glass fiber nonwoven fabric and reactively bonds with the material of the glass fiber nonwoven fabric to achieve a durable and wear-resistant coloration of the glass fiber nonwoven fabric.

### BACKGROUND OF THE INVENTION

1. Field of the Invention

The invention relates to a method for dyeing a glass fiber nonwoven fabric, and is particularly suited for pictorial dyeing of a glass fiber nonwoven fabric to produce colored design textures.

2. Description of Background Art

In contrast to woven glass fabric, a glass fiber nonwoven fabric is a thin material sheet made of glass fibers held together at least in part by a binder. Such a glass fiber nonwoven fabric is used, for example, in the building materials industry as a separating, insulating, or plastering aid. Such a glass fiber nonwoven fabric is also used for prevention of fouling in drains or gravel beds.

A method is known from EP Patent No. 0 376 664 B1 for producing a dyed woven glass fabric in which a water-containing woven glass fabric is dipped in a pigment dispersion, excess pigment dispersion is squeezed out, and the fabric is dried. Before dipping into the pigment dispersion the woven glass fabric is expanded by use of a water jet needle and water is removed from the woven fabric.

Surface printing of glass fiber nonwoven fabrics is also known. To this end, a layer of dye is applied to the textured surface of the glass fiber nonwoven fabric to more or less cover the uneven areas and fibrous structures of the glass fiber nonwoven fabric. However, a surface coating has the disadvantage that it cracks very easily under bending stress, and also may be easily rubbed off. For this reason, designs generally have been applied to glass fiber nonwoven fabrics only when it is absolutely necessary.

U.S. Pat. No. 3,922,445 describes a method for transfer printing of various materials. Basic or cationic dye together with a binder and an oxidizing agent are applied to an intermediate support. The oxidizing agent improves the transferability properties of the dyes used.

### SUMMARY OF THE INVENTION

The object of the present invention is to provide a method for dyeing a glass fiber nonwoven fabric which allows maximum color durability to be achieved.

This object is achieved according to one aspect of the invention by a method comprising applying a disperse dye to an intermediate support, placing the support proximate to a surface of a glass fiber nonwoven fabric, and thereafter applying heat to convert the dye to at least one of a gaseous state and an aerosol, whereby the dye at least partially penetrates the interior volume of the glass fiber nonwoven fabric and reactively bonds with the material of the glass fiber nonwoven fabric.

This object is achieved according to another aspect of the invention by a method comprising applying a disperse dye to a surface of a glass fiber nonwoven fabric, and thereafter applying heat to convert the dye to at least one of a gaseous state and an aerosol, whereby the dye at least partially penetrates the interior volume of the glass fiber nonwoven fabric and reactively bonds with the material of the glass fiber nonwoven fabric.

### DESCRIPTION OF EMBODIMENTS OF THE INVENTION

In one advantageous embodiment of the invention a sublimation dye is used. Such a dye is characterized in that the dye particles are converted from a solid state directly to the gaseous state as the result of heat treatment. Such dyes are thus suited in particular for carrying out the method of the invention, whereby as a result of heat treatment the gaseous or aerosol-like state of the dye particles necessary for the dyeing process is quickly achieved. The commercially available dyes Bafixan from BASF or Terasil from Ciba-Geigy, for example, may be used as sublimation dyes.

For the reactive bonding of the dye with the material of the glass fiber nonwoven fabric it is also advantageous when a water-soluble dye is used as dye. This allows the dye to be applied in an environmentally safe manner, using water as a solvent.

Good results may be achieved in particular with glass fiber nonwoven fabrics which are bound by a polymer, an acrylate, a polyacrylate, or an epoxy resin as binder. However, in no way is the method limited to this particular type of glass fiber nonwoven fabric.

For the heat treatment for converting the dye to the gaseous or aerosol-like state and for introducing the dye into the interior volume of the glass fiber nonwoven fabric, it has proven to be advantageous when the heat treatment is carried out at a temperature between 150° and 220° C. and with an application time between 10 seconds and 60 seconds.

In one practical embodiment of the invention, paper or a plastic film is used as an intermediate support for applying the dye to the glass fiber nonwoven fabric.

The introduction of the gaseous or aerosol-like dye into the interior volume of the glass fiber nonwoven fabric may be advantageously improved by carrying out pressure treatment, in particular during the heat treatment. In this manner the dye is pressed into the interior volume of the glass fiber nonwoven fabric in a targeted manner.

Chemical and/or physical additives such as defoamers and fillers may be added to the dye itself to contribute to the bonding or durability of the dye. The dye may be introduced into the glass fiber nonwoven fabric using, for example, a heating press such as a veneer press, such as that used in the same or similar manner by cabinetmakers. The dye is evaporated under the influence of the advantageous pressure and temperature levels.

In principle, it is also possible by means of the present invention to provide a large surface of a glass fiber nonwoven fabric with a uniform coloration or coarse colored texture. However, the advantages of the method are realized in particular by the application of image designs having very fine image textures in the range of several millimeters, with no bleeding of colors. For low dye consumption the method is particularly easy to carry out and therefore economical. The method may be performed using machines and equipment already present. The very attractive results have lasting durability and light resistance.

The method is explained in greater detail with reference to the following exemplary embodiment.

In a first step, the design texture to be ultimately transferred to the glass fiber nonwoven fabric was imprinted on an intermediate support, in this case paper. The printing was performed using a digital printing method, as commonly used in principle in commercially available inkjet printers and plotters. A digital printing method is understood to mean a printing method in which the print original is digitally stored and the printer is controlled by computer. An aqueous dispersion of the sublimation dye Bafixan by BASF was used as dye.

In a further step the design texture applied to the intermediate support was then transferred to the glass fiber nonwoven fabric. To this end, the printed paper was placed on the glass fiber nonwoven fabric and heated under pressure. A conventional heatable press was used for this purpose. Typical press parameters are a printing pressure between 5 and 15 bar and a temperature of approximately 180° C., which may be achieved by an electric heater. The pressure and temperature were maintained for a period of 50 seconds. The intermediate support was then removed, and the dye remained on the glass fiber nonwoven fabric, that is, in the interior volume of the glass fiber nonwoven fabric.

If the durability of the applied dye is to be further increased, in a subsequent step a protective layer may also be applied to the glass fiber nonwoven fabric. Examples of suitable protective layers are self-crosslinking colorless polymers.

Thus, the invention proceeds first from the consideration that the color-durability of a dye may be increased by the fact that the dye is not applied to the surface of the glass fiber nonwoven fabric, but instead is introduced into the interior volume thereof. This measure provides good protection from the dye being rubbed off by external influences. Further, the invention recognizes that, despite the closed structure of a glass fiber nonwoven fabric, dye can be introduced into the interior volume because the dye, which is applied to the surface of the glass fiber nonwoven fabric directly or by using an intermediate support, is converted to the gaseous state and/or to an aerosol by heat treatment. Lastly, the invention proceeds from the consideration that the durability of the applied dye is further increased by the fact that the dye reactively bonds with the material of the glass fiber nonwoven fabric.

Altogether, the method according to the invention results in a wear-resistant dye which is introduced into the interior volume of the glass fiber nonwoven fabric and is bound to the material of the glass fiber nonwoven fabric or is incorporated into the material by a chemical or physical bond. As a result of this reactive bonding, the glass fiber nonwoven fabric cannot become decolorized without destroying the material itself.

For introducing the dye into the interior volume of the glass fiber nonwoven fabric it is not necessary to completely convert the dye to the gaseous state. It is sufficient to entrain dye particles in a solvent vapor stream produced by the heat treatment, whereby a complete phase change of the dye particles is not absolutely necessary. Thus, the dye may also be partially in the form of an aerosol.

The dye may be applied or imprinted directly onto the surface of the glass fiber nonwoven fabric in the form of a pigment, for example, and by the subsequent heat treatment the dye is introduced into the interior volume of the glass fiber nonwoven fabric and fixed therein. As already noted, it is also possible to first apply the dye to an intermediate support and place the intermediate support on the surface of the glass fiber nonwoven fabric, and then by heat treatment introduce the applied dye from the intermediate support into the interior volume of the glass fiber nonwoven fabric and fix it therein.

The method is particularly advantageous for dyeing a glass fiber nonwoven fabric with pictorial designs which are applied to an intermediate support using a digital printing process, for example. The applied designs are characterized by good durability, color-fastness, and wear resistance.

A disperse dye is preferably used as the dye, whereby as a result of the heat treatment the solvent is evaporated and the dye particles present in the dispersion are converted to the gaseous state and/or to an aerosol. Particularly suited as a dye is an anthraquinone dye, in particular an indanthrene or alizarin dye derived from anthraquinone. Such dyes exhibit high stability to light.

While preferred embodiments of the invention have been depicted and described, it will be understood that various changes and modifications can be made other than those specifically mentioned above without departing from the spirit and scope of the invention, which is defined solely by the claims that follow.

What is claimed is:

1. A method of dyeing a glass fiber nonwoven fabric, the method comprising:
applying a disperse dye to an intermediate support;
placing the support proximate to a surface of the glass fiber nonwoven fabric; and
thereafter applying heat to convert the dye to at least one of a gaseous state and an aerosol, whereby the dye at least partially penetrates the interior volume of the glass fiber nonwoven fabric and reactively bonds with the material of the glass fiber nonwoven fabric

2. A method according to claim 1, wherein said dye is an anthraquinone dye.

3. A method according to claim 2, wherein said dye is an indanthrene or alizarin dye derived from anthraquinone.

4. A method according to claim 1, wherein said dye is a sublimation dye.

5. A method according to claim 1, wherein said dye is water-soluble.

6. A method according to claim 1, wherein the glass fiber nonwoven fabric is bound by a binder.

7. A method according to claim 6, wherein the binder is selected from the group consisting of a polymer, an acrylate, a polyacrylate, and an epoxy resin.

8. A method according to claim 1, wherein said heating step is carried out at a temperature between 150° C. and 220° C. for between 10 seconds and 60 seconds.

9. A method according to claim 1, wherein said intermediate support is selected from the group consisting of paper or plastic film.

10. A method according to claim 1, wherein pressure is applied to said intermediate support during the application of heat.

11. A method of dyeing a glass fiber nonwoven fabric, the method comprising:
applying a disperse dye to a surface of the glass fiber nonwoven fabric; and
thereafter applying heat to convert the dye to at least one of a gaseous state and an aerosol, whereby the dye at least partially penetrates the interior volume of the glass fiber nonwoven fabric and reactively bonds with the material of the glass fiber nonwoven fabric

12. A method according to claim 11, wherein said dye is an anthraquinone dye.

13. A method according to claim 12, wherein said dye is an indanthrene or alizarin dye derived from anthraquinone.

14. A method according to claim 11, wherein said dye is a sublimation dye.

15. A method according to claim 11, wherein said dye is water-soluble.

16. A method according to claim 11, wherein the glass fiber nonwoven fabric is bound by a binder.

17. A method according to claim 16, wherein the binder is selected from the group consisting of a polymer, an acrylate, a polyacrylate, and an epoxy resin.

18. A method according to claim 11, wherein said heating step is carried out at a temperature between 150° and 220° C. for between 10 seconds and 60 seconds.

19. A method according to claim 11, wherein pressure is applied to the glass fiber nonwoven fabric during the application of heat.
